(19) United States
(12) Patent Application Publication
(10) Pub. No.: US 2009/0112936 A1
(43) Pub. Date: Apr. 30, 2009

(54) METHOD OF AUTOMATICALLY SYNCHRONIZING DATA

(75) Inventors: Steven Broeils Luitjens, Eindhoven (NL); Franciscus Lucas Antonius Johannes Kamperman, Eindhoven (NL); Declan Patrick Kelly, Shanghai (CN); Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,831

(22) PCT Filed: Jan. 23, 2006
(86) PCT No.: PCT/IB06/50243

§ 371 Date: Mar. 14, 2008

(30) Foreign Application Priority Data
Jan. 31, 2005 (EP) 05100626.0

(51) Int. Cl. G06F 17/30

(52) U.S. Cl. 707/201; 707/E17.01; 707/E17.032

(57) ABSTRACT

There is provided a system operable to execute automatic synchronization therein. The system comprises a first data memory (20) for storming a first data set, said first memory (20) being coupled to a communication network (10). The system further includes a portable device (100) including a second data memory (130) for storing a second data set, said portable device being provided with a wireless transceiver (150) wherein said transceiver (150) includes a data memory (320) for storing a record of synchronization updates required to synchronize the first and second data sets into mutual conformity. The transceiver (150) is operable when introduced together with the portable device (100) within communication range of the communication network (10, 30a) to at least partially synchronize automatically said first and second data sets.

The present invention relates to methods of automatically synchronizing data. Moreover, the invention also relates to apparatus and devices operable to employ the methods when automatically synchronizing data. Furthermore, the invention also relates to software executable on computing hardware for implementing the methods.

An issue of data synchronization arises when there are multiple devices or systems each provided with a set of data, wherein the multiple sets of data are to be maintained so as to be mutually consistent and communication between the multiple devices or systems is intermittent. A situation may arise where one of the sets of data is updated whilst the other sets of data remain un-updated until synchronization of the data is executed.

Synchronization is contemporarily found to be time consuming when at least one of:
(a) the amount of data to be synchronized is relatively large; and
(b) a communication bandwidth between the devices or systems for synchronization purposes is relatively restricted.

Moreover, synchronization can also render a given system or device involved interrupted or only partially available to users during synchronization, for example on account of memory storage such as harddisk drives handling synchronization data.

Technical problems associated with data synchronization are known. For example, a published United States patent application no. US2002/0147660 is concerned with scheduling, tracking, and synchronization of events with personal portable computers using bar code input. The application describes a mobile computer designed to be a hand-held unit and incorporating a bar code reader. Moreover, the computer incorporates trigger switches on one or more sides of the computer unit, the switches being user pressable to activate the bar code reader. The computer optionally further includes a microphone, a speaker, function keys and a touch screen display. In operation, the computer has an internally stored user identification; the computer is employed by its user to read a bar code symbol, to process data read from the bar code symbol, to assemble the data together with user identification to generate a message, and to transmit automatically the message via a wireless communication link connected to a network according to a registry server included in the network, the registry server being operable to schedule and track the symbol data and the user identification information. When a user contacts the server at a later time, the mobile computer is updated or synchronized with new data from the registry server based upon processing that has occurred since the computer last communicated with the network.

It is an object of the invention to provide a method of synchronizing data which is capable of causing less interruption to users.

According to a first aspect of the present invention, there is provided a system operable to execute automatic synchronization therein, said system comprising:
(a) a first data memory for storing a first data set, said first data memory being coupled to a communication path;
(b) a portable device including a second data memory for storing a second data set, said portable device being provided with a transceiver wherein said transceiver includes a data memory for storing a record of synchronization updates required to synchronize the first and second data sets into mutual conformity,
   wherein the wireless transceiver is operable when introduced together with the portable device within communication range of the communication path to at least partially synchronize automatically said first and second data sets.

The invention is of advantage in that data synchronization is more easily and conveniently achieved.

For example, the system is capable of automatically, and therefore transparent to the user, deciding on the urgency of synchronization, thereby reducing a likelihood that a user of the system takes action or makes decisions which are inconsistent with data which has not yet been synchronized.

Optionally, in the system, the transceiver is wireless and/or comprises a radio frequency tag, said tag being configurable to function autonomously to the device for supervising and supporting data synchronization between the first and second data sets. The tag is capable of providing for non-contact communication within the system which is convenient when performing data synchronization within the system without needing to physically connect electronic items thereof together.

Optionally, in the system, the data memory of the transceiver is implemented as non-volatile memory such that said transceiver is operable to support mutual synchronization of the first and second data sets when the portable device is in a switched-off state. By such operation, synchronization can be achieved whilst the device is at least partially de-energized, for example at night when the user is not using the device.

Optionally, in the system, the wireless transceiver is incorporated into a data carrier for conveying data between the portable device and the first data memory, said transceiver being operable to supervise synchronization between the first and second data sets and said data carrier being operable to convey synchronization data objects between the portable device and the first data memory as determined by the transceiver. Incorporation of the transceiver within the device is beneficial to the user in that there are fewer individual parts to have to handle.

Optionally, as an alternative within the system, the data carrier is an optical data disc and the wireless transceiver is implemented as a radio frequency tag integrally incorporated into the disc. Such an arrangement is especially convenient and effective when more substantial amounts of data are to be transferred between the device and the first data memory. The optical disc can be supplemented with a solid-state memory card, or the solid-state memory card can be employed as a substitute for the optical disc.

Optionally, in the system, the first data memory and its associated communication path comprise a data server coupled to a communication network. Such a network is beneficially the Internet.

Optionally, in the system, the portable device is provided with a user-interface for presenting to a user of the device an indication of pending synchronization operations and their relative priorities. Provision of the interface enables the user to at least partially intervene, if so desired, to supervise data synchronization. Personal preferences can also be employed to prioritize synchronization or determine a need for synchronization. For example, if a pop song has become available, it will be the user's preference to synchronize data to download the new pop song rather than synchronize data regarding older pop songs which are not of great interest to the user.

Optionally, in the system, the portable device is provided with a user-interface for presenting to a user of the device an indication of pending synchronization operations, said interface comprising an alarm for warning the user when more than a predetermined number of data objects are pending for synchronization between the first and second data sets. Such a warning can assist to prevent the device from malfunctioning when the first and second data sets mutually diverge as a result of too infrequent synchronization. The alert is optionally dependent upon a given software application and its immediate needs to ensure consistency of synchronization.

Optionally, in the system, the portable device is provided with a user-interface for entering data pertinent to the wireless transceiver, said user-interface including at least one of: a keypad, a stylus pad, a microphone, a pixel camera, a magnetic reader, an optical data disc reader, a magnetic disc reader, a magnetic strip reader, an optical scanning reader.

Optionally, in the system, the portable device is implemented to be one or more of: a personal data assistant (PDA), a mobile telephone, a cell phone, a portable computer, an industrial portable data entry terminal, an electronic game, a portable cash payment terminal, a portable music player, a portable video player, a GPS terminal.

Optionally, in the system, the wireless transceiver is operable to implement concurrent bidirectional synchronization between the first and second data sets. Such bi-directional synchronization permits especially efficient and rapid data synchronization when both first and second data sets need to be mutually updated.

Optionally, in the system, the radio frequency tag is detachable from the device. Such a configuration enables several different types of RF tags to be used for synchronizing the device to a plurality of different systems.

According to a second aspect of the invention, there is provided a method of implementing automatic synchronization within a system, said method comprising steps of:
(a) configuring a first data memory for storing a first data set, said first data memory being coupled to a communication path;
(b) configuring a portable device to include a second data memory for storing a second data set;
(c) providing said portable device with a wireless transceiver, said transceiver including a data memory;
(d) storing a record of synchronization updates required to synchronize the first and second data sets into mutual conformity; and
(e) introducing together the portable device and the wireless transceiver within communication range of the communication path to at least partially synchronize automatically said first and second data sets.

According to a third aspect of the invention, there is provided a portable device including a second data memory for storing a second data set, said portable device being provided with a wireless transceiver wherein said transceiver includes a data memory for storing a record of synchronization updates required to synchronize the second data set into mutual conformity with a first data set, said first data set being stored in a first data memory coupled to a communication path, wherein the wireless transceiver is operable when introduced together with the portable device within communication range of the communication path to at least partially synchronize automatically said first and second data sets.

According to a fourth aspect of the invention, there is provided a wireless transceiver for including with the device according to the fourth aspect of the invention, said transceiver including a memory local thereto configured to supervise automatic synchronization of said device with a data set stored remotely from the device.

Optionally, the wireless transceiver is implemented as a radio frequency tag, said tag being operable autonomously relative to said device.

According to a fifth aspect of the invention, there is provided software executable in a system according to the first aspect of the invention for implementing automatic data synchronization therein according to a method according to the second aspect of the invention.

According to a sixth aspect of the invention, there is provided a data carrier provided with a wireless transceiver integral therein, said wireless transceiver being configured with data memory local thereto for supervising data synchronization, said data carrier being configurable to convey one or more data objects required for implementing automatic synchronization.

Features of the invention are capable of being combined in any combination without departing from the scope of the invention.

Embodiments of the invention will now be described, by way of example only, with reference to the following diagrams wherein:

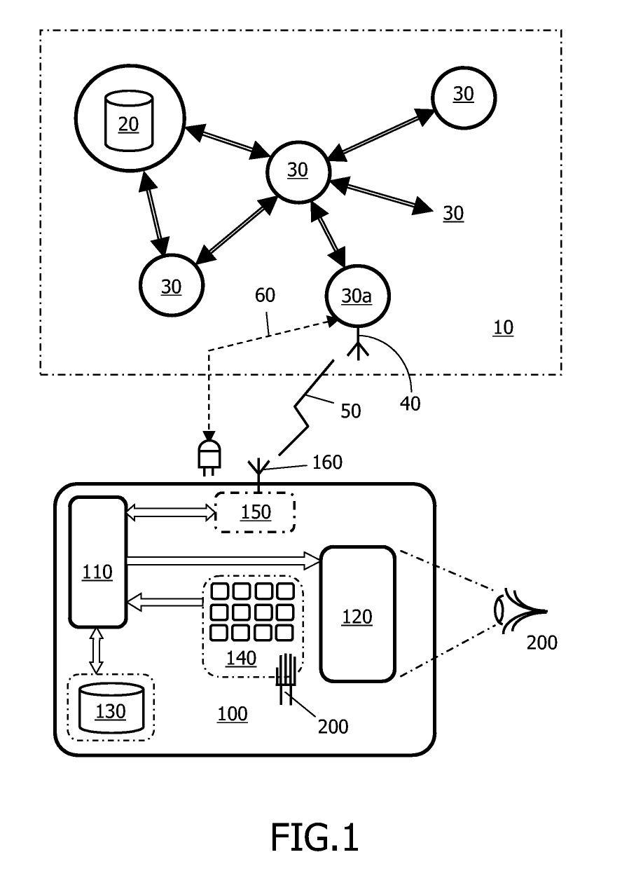

FIG. 1 is an illustration of a system according to the invention in which automatic synchronization of data occurs during operation of the system;

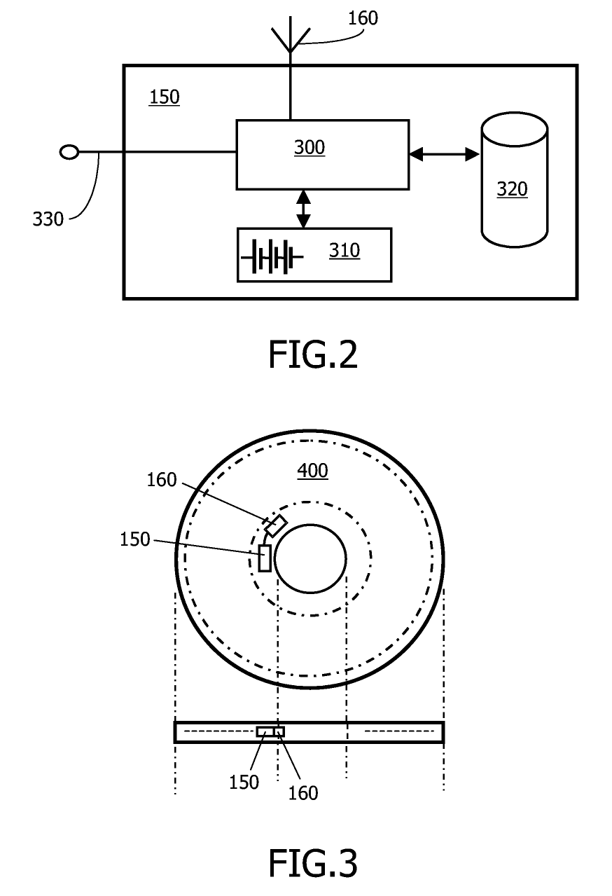

FIG. 2 is an illustration of a radio frequency (RF) tag associated with a portable device forming a part of the system of FIG. 1; and

FIG. 3 is an illustration of an optical data carrier including the radio frequency (RF) tag of FIG. 2.

Referring to FIG. 1, there is shown a system which is operable to synchronize automatically data between a network 10 and a portable device 100. The network 10 comprises a data server 20 including, amongst other data, a first set of data stored therein. Additionally, the network 10 includes a distributed arrangement of at least partially mutually interconnected nodes 30. The network 10 can, for example, correspond to the Internet, although other network configurations are also possible. One of the nodes 30, namely a node 30a, is provided with a wireless transceiver 40 for providing bidirectional wireless communication 50 to the portable device 100.

The portable device 100 is susceptible to being implemented as a personal data assistant (PDA), a mobile telephone, a portable computer, an industrial portable data terminal, an electronic game, a cash-payment terminal, a Global Positioning System (GPS) portable or in-vehicle terminal, although numerous other implementations for the device 100 are also feasible. The device 100 includes a processor 110 coupled to a pixel display 120 for presenting images to a user 200 of the device 100. A generic display is susceptible to being used to implement the display 120, for example a pixel liquid crystal display (LCD). The device 100 further includes a data storage memory 130 for storing a second set of data, the storage memory 130 being coupled to the processor 110. Moreover, the device 100 includes a data entry unit 140 which can be implemented to include one or more of a keypad, a stylus pad, a microphone, a pixel camera, a magnetic reader, an optical data disc reader, a magnetic disc reader, and an optical scanning reader and similar types of data inputs or sensors. For providing a communication path from the device 100 to the network 10, the device 100 includes, or has associated therewith for example as an optional retrofit component, a radio frequency (RF) tag 150 including an associated antenna 160, for example stub or patch antenna, for providing wireless communication to the wireless transceiver 40 of the node 30a. Optionally, the device 100 further has provision for a direct physical connection 60 for rapid transmission of data between the node 30a and the device 100, for example either via the RF tag 150 or directly to the processor 110 or both.

The RF tag 150 is illustrated in greater detail in FIG. 2 wherein the tag 150 includes the aforesaid antenna 160 coupled to an electronic module 300 including RF circuits for outputting and receiving signals from the antenna 160 together with a processor operable to perform data processing. Moreover, the tag 150 includes a source of power 310 either derived from the device 100 or independently therefrom, for example when the tag 150 is implemented to be a retrofittable detachable option for the device 100; for example the source of power 310 can be derived from read RF power. Furthermore, the RF tag 150 includes a data memory 320 coupled to the electronic module 300; the data memory 320 is beneficially implemented using solid-state electronic components.

Operation of the device 100 and the network 10 will now be described with reference to FIG. 1. The aforesaid first and second sets of data stored in the data server 20 and the storage memory 130 respectively are to be synchronized. Such synchronization is not limited to the first and second data sets being identical in structure but merely having identical information where an operator or designer of the network 10 and the device 100 deem it desirable to have mutual correspondence of information content, for example important lists of parameters, postal addresses, telephone numbers, software applications, calendar details, geographical map details, product price lists, entertainment data (AV) and so forth. The device 100 is, from time to time, carried and operated by its operator 200 at spatial locations remote from the network 10 whereat wireless communication via the RF tag 150 to the network 10 is not feasible; during such periods, it is possible that the first data set stored in the server 20 is updated, for example software upgrades, new price list, new catalogue list, postal addresses supplemented or modified. Moreover, it is also possible that the second data set stored in the storage memory 130 is also updated, for example by way of the data entry unit 140. If the device 100 were a conventional device, subsequent communication between the device 100 and the network 10 would render the device 100 less available, or potentially unavailable, to the user 200 during subsequent synchronization to bring the first and second data sets into mutual conformity.

The inventors have appreciated in general that synchronization of portable devices can be cumbersome. Conventionally, the portable devices need to be connected to a network, for example via Ethernet or Universal Serial Bus (USB) wired or wireless, to a system host so that the devices and the system host communicate regarding new data available from the host for the devices and/or from the devices to the host. When relatively large quantities of data need to be communicated, such synchronization can take a relatively long time to execute. Thus, contemporary synchronization procedures require user effort and are time-consuming. Moreover, synchronization takes energy which can represent a severe load when the devices are portable and are provided with modest associated sources of power, for example rechargeable batteries or disposable miniature button cells.

In the system depicted in FIG. 1, protocols are employed which reduce a quantity of data to be communicated between the network 10 and the device 100. Moreover, inclusion of the RF tag 150 potentially circumvents a need to make a direct physical connection between the device 100 and the network 10. A data carrier is provided between the network 10 and the device 100 as will be further elucidated later. This data carrier can be implemented by way of the RF tag 150 itself or by way of a data medium, for example an optical data-storage disc.

In one operating protocol, the network 10 employs its server 20 to record updates for the device 100 on a data medium, for example an optical data disc, which the user 200 at his or her convenience inserts into the device 100 for its data entry unit 140 to interrogate; in such a manner, the second data set of the device 100 can be updated into synchronism with the first data set store in the server 20. As soon as the device 100 reads data from the data medium, it updates the second set of data into synchronism with the first data set. Updates provided on the data carrier can be provided with an expiration time/date after which the data medium is deemed to be outdated and can be erased for re-use, thrown away or otherwise discarded. Conversely, when the device 100 is required to update the server 20, the data medium is used to convey information derived from the second data set to update the first data set at the server 20.

In another operating protocol, the RF tag 150 is employed for conveying data between the network 10 and the device 100. The device 100 then needs to be placed near the node 30a, namely within RF operating range of the RF tag 150, to receive updates regarding changes to the first data set so as to update the second data set at the device 100. When conveying data from the network 10, for example from the server 20, to the device 100, the RF tag 150 is activated externally from the server 20 and updates are transferred to the tag 150; when the RF tag 150 is energized independently relative to a remainder of components included in the device 100, such updates do not consume energy of the device 100 itself. Preferably, when the RF tag 150 is powered independently relative to a remainder of the device 100, synchronization takes place as soon as the device 100 is activated for use.

Thus, when implementing the device 100, it is beneficial to use the RF tag 150 provided with data memory local thereto, namely the data memory 320. The memory 320 of the tag 150 is capable of functioning as a non-volatile cache. Moreover, employing the RF tag 150 for implementing synchronization is also beneficial in that synchronization of the device 100 to the network 10 and vice versa can be implemented without involving user intervention, namely automatically; for example, selected data transfer for synchronization purposes can be communicated via the RF tag 150 during nights when the device 100 is not required to be active to serve its user 200.

It is of benefit when implementing the invention that the RF tag 150 is capable of functioning independently of the device 100, but is nevertheless a logical part of the device 100; for example, as elucidated earlier, the RF tag 150 can be implemented as a detachable add-on component to the device 100. The second protocol is so arranged that the RF tag 150 is provided from the device 100 with an indication of a latest state of the device 100, for example which update version of software is stored in the second data set in the storage memory 130. Such an indication is, for example, transferred from the device 100 to its RF tag 150 when the RF tag 150 is attached to the device 100; when the device 100 is subsequently switched on, actual synchronization of data occurs between the first and second data sets as a function of the aforesaid indication of the state of the device 100.

Optionally, the RF tag 150 is an integral part of the device 100 such that transfer of data in preparation for synchronization occurs whilst the device 100 is switched off and placed in vicinity of a RF transfer region associated with the node 30a, for example within a cradle designed to receive the device 100.

As a further option, the RF tag 150 can be physically a part of the aforesaid data medium, for example an optical disc data carrier 400 as illustrated in FIG. 3. In FIG. 3, the RF tag 150 is an integral part of the data carrier 400, wherein the RF tag 150 is configured to employ a thin metal film for implementing the antenna 160. Preferable, the RF tag 150 is attached to the data carrier 400 in some secure way, for example molded into the carrier 400. In such an embodiment, the data input 140 is capable of reading and writing data to the optical disc 400. Data stored on the disc 400 is updated as soon as, and not before, the disc 400 is accessed; such a sequence of operation is of benefit in that data in the RF tag 150 is updated before the disc 400, thereby preventing an update of the disc 400 which is not necessary and thereby reducing synchronization time and energy dissipated during synchronization.

Apart from supporting more extensive synchronization of the first and second data sets of the network 10 and device 100 respectively, the RF tag 150 is also capable of being used to alert the user 200 that synchronization is required, for example in combination with locking records in one or more of the first and second data sets. Such locking is of especial benefit when local data memory space within the RF tag 150 is limited or a substantial synchronization update between the first and second data sets is required. The RF tag is thereby capable of preventing divergence of the first and second data sets, thereby preventing errors, deadlocks and mishaps.

In one embodiment of the invention, the network 10 corresponds to a song distribution network communicating data objects corresponding to songs. The device 100 is then beneficially an MP-3 type portable digital music player. Data corresponding to new songs is at intervals loaded onto the server 20 of the network 10 to supplement the first data set. Moreover, periodically, data objects corresponding to old (out of date) songs are removed from the first data set stored at the server 200. Downloading the first data set from the server 20 to the device 100 would be a major time consuming task. Such a task is avoided by synchronization wherein the RF tag 150 maintains a record of songs stored in the storage memory 130 and interfaces between the node 30a and the device 100 to ensure that only new songs most recently loaded onto the server 20 and not yet recorded on the memory storage 130 are transferred during synchronization. Personal preferences can be allowed to determine priority of data synchronization, for example pop songs desired by the user can be prioritized higher for synchronization than older songs of relatively low interest to the user 200.

In the aforementioned second protocol pertinent to the RF tag 150, a visual and/or audio warning is provided to the user 200 when the user 200 leaves a given environment, for example an office, in an event where more than a predetermined number of updates are pending to synchronize the first and second data sets. A record of the updates pending is beneficially stored in data memory associated with the RF tag 150.

The device 100 is also beneficially configurable, at commencement of executing a software application therein on the processor 110, to check with the RF tag 150 whether or not an update is pending either for the application itself or data stored within the device 100 which the software application needs to access. Such a warning is beneficially implemented by way of an audio alarm or visual alarm or both.

The device 100 is also optionally capable of being configured so that the processor 110 is operable to shut down a software application executing therein if the processor 110 determines from the RF tag 150 that more than a predetermined number of updates from the server 20 is pending. Such intervention of the processor 110 is beneficial in that it can prevent the device 100 executing inappropriate combinations of software applications and data that can cause the processor 110 to malfunction, for example “crash” to frustration of the user 200.

Optionally, the network 10 and the device 100 can be configured to transfer meta data therebetween, for example via the RF tag 150. Such meta data can be used to present to the user 200 on the display 120 program content listings for user selection as well as conveying a subsequent preferred selection of program content from the device 100 to the network 10 to cause corresponding data to be downloaded from the server 20 via the node 30a to the device 100 where such program content does not already exist in the storage memory 130. Beneficially, the RF tag 150 is integral to a data medium, for example an optical data storage disc; physical transfer of the data disc between the device 100 and the node 30a of the network 10 can then be used for synchronization purposes.

Beneficially, the RF tag 150 is configurable to handle multiple levels of pending update for synchronization purposes. An example of such multiple levels arises in a method of synchronization comprising steps of:
(a) transferring information to the system to determine whether or not the first data set stored in the server 20 requires updating;
(b) communicating a need for update from the network 10 to the RF tag 150;
(c) determining in the electronic module 300 whether or not an update is required to bring the second data set stored in the device 100 into conformity with the first data set;
(d) when updating of the second data set into conformity with the first data set is required, identifying those items of data which need to be updated; and
(e) transferring data from the server 20 via the node 30a to the device 100 for at least partially updating the second data set stored at the memory storage 130, or for alerting the user.

Synchronization can also arise from the device 100 to the network 10 in a method of synchronization comprising steps of:
(f) transferring information to the system to determine whether or not the first data set stored in the server 20 requires updating;
(g) communicating a need for update from the network 10 to the RF tag 150;
(h) determining in the electronic module 300 whether or not an update is required to bring the first data set stored in the network 10 into conformity with the second data set stored in the device 100;
(i) when updating of the first data set into conformity with the second data set is required, identifying those items of data which need to be updated; and
(j) transferring data from the device 100 via the node 30a to the server 20 for updating the first data set stored therein.

Selective synchronization between the device 100 and the system 10 can occur concurrently in a bidirectional manner with the RF tag 150 effectively supervising such associated synchronization.

Optionally, the device 100 can be configured to present to its viewer 200 a list of priorities of data objects which need to be updated by synchronization; some data objects beneficially include data fields indicative of their respective mutual priorities with regard to a need for synchronization. The user 200 is then provided on the device 100, for example via the display 120 and the data input 140, with an option of selecting amongst such priorities to determine in what order and when synchronization between the network 10 and the device 100 is executed. The user 200 is also beneficially provided with an indication on the device 100 of available energy therein for performing synchronization functions to bring the first and second data sets at least partially into synchronization.

It will be appreciated that embodiments of the invention described in the foregoing are susceptible to being modified without departing from the scope of the invention as defined by the accompanying claims.

In the accompanying claims, numerals and other symbols included within brackets are included to assist understanding of the claims and are not intended to limit the scope of the claims in any way.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed to be a reference to the plural and vice versa.

1-18. (canceled)

19. A system operable to execute automatic synchronization therein, said system comprising:
(a) a first data memory (20) for storing a first data set, said first data memory (20) being coupled to a communication path (10, 30, 30a);
(b) a portable device (100) including a second data memory (130) for storing a second data set, said portable device (100) being provided with a transceiver (150) wherein said transceiver (150) includes a data memory (320) for storing a record of synchronization updates required to synchronize the first and second data sets into mutual conformity, the transceiver (150) being operable when introduced together with the portable device (100) within communication range of the communication path (10, 30, 30a) to at least partially synchronize automatically said first and second data sets,
wherein the synchronization is performed in accordance to records stored in said data memory (320), said records including updates required to synchronize the first and the second data sets into mutual conformity.

20. A system as claimed in claim 19, wherein the transceiver (150) comprises a radio frequency tag (150), said tag (150) being configurable to function autonomously to the device (100) for supervising and supporting data synchronization between the first and second data sets.

21. A system as claimed in claim 19, wherein said data memory (320) of the transceiver (150) is implemented as non-volatile memory such that said transceiver (150) is operable to support mutual synchronization of the first and second data sets when the portable device (100) is in a switched-off state.

22. A system as claimed in claim 19, wherein said wireless transceiver (150) is incorporated into a data carrier for conveying data between the portable device (100) and the first data memory (20), said transceiver (150) being operable to supervise synchronization between the first and second data sets and said data carrier being operable to convey synchronization data objects between the portable device (100) and the first data memory (20) as determined by the transceiver (150).

23. A system as claimed in claim 22, wherein the data carrier is an optical data disc and the transceiver (150) is implemented as a radio frequency tag integrally incorporated into the disc.

24. A system as claimed in claim 19, wherein the first data memory (20) and its associated communication path (10, 30, 30a) comprise a data server (20) coupled to a communication network (10).

25. A system as claimed in claim 19, wherein the portable device (100) is provided with a user-interface (120) for presenting to a user (200) of the device (100) an indication of pending synchronization operations and their relative priorities.

26. A system as claimed in claim 19, wherein the portable device (100) is provided with a user-interface (120) for presenting to a user (200) of the device (100) an indication of pending synchronization operations, said interface (120) comprising an alarm for warning the user when more than a predetermined number of data objects are pending for synchronization between the first and second data sets.

27. A system as claimed in claim 19, wherein the portable device (100) is provided with a user-interface (140) for entering data pertinent to the transceiver (150), said user-interface (140) including at least one of: a keypad, a stylus pad, a microphone, a pixel camera, a magnetic reader, an optical data disc reader, a magnetic disc reader, a magnetic strip reader, an optical scanning reader.

28. A system as claimed in claim 19, wherein the portable device (100) is implemented to be one or more of: a personal data assistant (PDA), a mobile telephone, a cell phone, a portable computer, an industrial portable data entry terminal, an electronic game, a portable cash payment terminal, a portable music player, a portable video player, a GPS terminal.

29. A system as claimed in claim 19, wherein the transceiver (150) is operable to implement concurrent bi-directional synchronization between the first and second data sets.

30. A system as claimed in claim 20, wherein said radio frequency tag (150) is detachable from the device (100).

31. A method of implementing automatic synchronization within a system, said method comprising steps of:
(a) configuring a first data memory (20) for storing a first data set, said first data memory (20) being coupled to a communication path (10, 30, 30a);
(b) configuring a portable device (100) to include a second data memory (130) for storing a second data set;
(c) providing said portable device (100) with a transceiver (150), said transceiver including a data memory (320);
(d) storing a record of synchronization updates required to synchronize the first and second data sets into mutual conformity; and
(e) introducing together the portable device (100) and the transceiver (150) within communication range of the communication path (10, 30, 30a) to at least partially synchronize automatically said first and second data sets,
wherein the synchronization is performed in accordance to said stored records.

32. A portable device (100) including a second data memory (130) for storing a second data set, said portable device (100) being provided with a wireless transceiver (150) wherein said transceiver (150) includes a data memory (320) for storing a record of synchronization updates required to synchronize the second data set into mutual conformity with a first data set, said first data set being stored in a first data memory (20) coupled to a communication path (10, 30, 30a), wherein the transceiver (150) is operable when introduced together with the portable device (100) within communication range of the communication path (10, 30, 30a) to at least partially synchronize automatically said first and second data sets, the synchronization being performed in accordance to said stored records of synchronization updates.

33. A transceiver (150) for including with the device (100) as claimed in claim 32, said transceiver (150) including a memory (320) local thereto configured to supervise automatic synchronization of said device (100) with a data set stored remotely from the device (100), the memory having stored records of synchronization updates, wherein the synchronization is performed in accordance to said stored records of synchronization updates.

34. A transceiver (150) as claimed in claim 33 implemented as a radio frequency tag (150), said tag (150) being operable autonomously relative to said device (100).

35. Software executable in a system as claimed in claim 19 for implementing automatic data synchronization therein according to a method of implementing automatic synchronization within a system, said method comprising steps of:
(a) configuring a first data memory (20) for storing a first data set, said first data memory (20) being coupled to a communication path (10, 30, 30a);
(b) configuring a portable device (100) to include a second data memory (130) for storing a second data set;
(c) providing said portable device (100) with a transceiver (150), said transceiver including a data memory (320);
(d) storing a record of synchronization updates required to synchronize the first and second data sets into mutual conformity; and
(e) introducing together the portable device (100) and the transceiver (150) within communication range of the communication path (10, 30, 30a) to at least partially synchronize automatically said first and second data sets,
wherein the synchronization is performed in accordance to said stored records.

36. A data carrier (400) provided with a wireless transceiver (150) integral therein, said transceiver (150) being configured with data memory (320) local thereto for supervising data synchronization, said data carrier (400) being configurable to convey one or more data objects required for implementing automatic synchronization, the memory (320) having stored records of synchronization updates, wherein the synchronization is performed in accordance to said stored records of synchronization updates.
